(19) United States
(12) Patent Application Publication
(10) Pub. No.: US 2011/0186042 A1
(43) Pub. Date: Aug. 4, 2011

(54) Mirror For Solar Thermal Power Plants, Comprising Plasticizer-Containing Polyvinyl Acetal Films

(75) Inventors: Uwe Keller, Bonn (DE); Martin Steuer, Liderbach (DE)

(73) Assignee: KURARAY EUROPE GMBH, Frankfurt (DE)

(21) Appl. No.: 13/015,898

(22) Filed: Jan. 28, 2011

(30) Foreign Application Priority Data
Feb. 3, 2010 (EP) 10152521.7

(51) Int. Cl. F24J 2/10; B32B 27/30

(52) U.S. Cl. 126/684; 156/308.2

(57) ABSTRACT

plasticizer-containing films based on polyvinyl acetal where the polyvinyl alcohol content of the polyvinyl acetal is less than 20 wt % are useful for production of mirrors for solar thermal power plants which exhibit low creep of the adhesive layer, and low corrosion of the specular surface.

### CROSS-REFERENCE TO RELATED APPLICATION

This application claims priority to European Patent Application No. EP 10152521.7 filed Feb. 3, 2010 which is herein incorporated by reference.

### BACKGROUND OF THE INVENTION

1. Field of the Invention

The invention relates to the production of mirror systems for solar thermal power plants using plasticizer-containing films based on polyvinyl acetal.

2. Background Art

Solar thermal power plants use large minor surfaces for concentrating sunlight. These minor systems usually consist of a transparent front cover and a transparent or nontransparent rear backing, such that a reflecting layer which reflects sunlight as well as possible is applied to the front cover or the rear backing. The cover and backing are then bonded using an adhesive system.

Ethylene-vinyl acetate (EVA), silicone or plasticizer-containing polyvinyl butyral (PVB) are examples of adhesive systems used for such mirrors. WO 2007/108861 and U.S. Pat. No. 4,511,618 describe the production of planar or curved (paraboloid) minor systems for solar thermal power plants, where a mirrorized pane of glass is bonded to a non-mirrorized pane of glass using a PVB film. The properties of the PVB films are not described in greater detail.

Adhesive films for use in mirrors for solar thermal power plants must have the following properties:
high adhesion,
low corrosiveness with the mirror materials,
high edge stability, i.e., no turbidity or delamination due to moisture penetrating at the open edges or delamination due to plasticizers evaporating over time,
high UV stability (long-term behavior),
adequate thermal stability,
low creep tendency even at elevated temperatures,
high dimensional stability,
uniform thickness profile,
good processability,
low manufacturing costs.

### SUMMARY OF THE INVENTION

It has been surprisingly and unexpectedly discovered that these requirements can be substantially achieved by mirrors bonded with a plasticizer-containing film based on polyvinyl acetal with a low residual polyvinyl alcohol content. It has been found in particular that the creep tendency of such a plasticizer-containing film under a thermal load depends to a significant extent on its polyvinyl alcohol content, molecular weight, degree of crosslinking or acetalization conditions in production.

### BRIEF DESCRIPTION OF THE DRAWINGS

FIG. 1 shows the schematic structure of a one embodiment inventive mirror system.

FIGS. 2 and 3 illustrate measurement of creep in a mirror assembly bound by a plasticizer-containing film.

### DETAILED DESCRIPTION OF THE PREFERRED EMBODIMENTS

The subject matter of the present invention thus pertains to mirrors for solar thermal power plants, comprising a laminate of

a) a transparent front cover,
b) one or more sunlight-reflecting layers,
c) at least one plasticizer-containing film based on polyvinyl acetal, and
d) a rear cover,
wherein the plasticizer-containing film c) based on polyvinyl acetal contains polyvinyl acetal which has a polyvinyl alcohol content of less than 20 wt %.

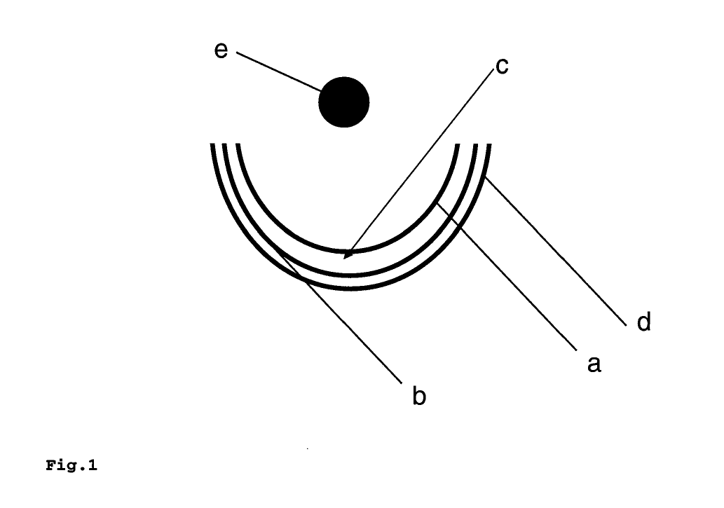

As illustrated in FIG. 1, the reflective layer (b) is applied to the rear cover (d) and is bonded to the transparent front cover (a) via the layer (c). The arrangement shown here is used in a linear concentrator, where incident sunlight from above is concentrated on a point labeled as (e). The dissipation of heat at point (e) may be accomplished through tubes containing a corresponding fluid heating medium.

In a first variant of the invention, the film c) has a creep tendency of less than 5 mm after 7 days at a temperature of 100° C., this creep being determined on a laminate structure of 3 mm planar float glass/0.76 mm film c)/3 mm float glass. This method is described in greater detail hereafter. The creep tendency of the plasticizer-containing polyvinyl acetal film c) is more preferably less than 3 mm, yet more preferably less than 2 mm, and most preferably less than 1 mm.

As an alternative to measurement of the creep properties, the melt-flow rate (“MFR”) may also be used to characterize the film. For example, the MFR (100° C., 21.6 kg) of the inventive film is preferably less than 340 mg/10 min, and more preferably less than 280 mg/10 min, each with a lower limit of 100 mg/10 min.

Due to the low polyvinyl alcohol content, plasticizers of low polarity may be used in a relatively large amount, which further improves the moisture resistance of the films without unduly increasing the creep tendency of the film.

A sufficiently low polyvinyl alcohol content here not only has a direct effect on the moisture uptake by the film but also at the same time is a prerequisite for the use of strongly apolar plasticizers having a good compatibility with polyvinyl acetal. An additional contribution toward a reduction in the moisture uptake by the film can be obtained through the choice of such a plasticizer. A low moisture uptake is manifested in a low corrosiveness of the film with respect to the mirror material b).

For this reason, polyvinyl alcohol contents of less than 20.0 wt % are used for films used according to this invention. The polyvinyl acetals used according to this invention preferably have a polyvinyl alcohol content of less than 18 wt %, more preferably less than 17 wt % and in particular less than 16 wt %. The polyvinyl alcohol content should not drop below 12 wt %.

Films used in the invention may contain one or more polyvinyl acetals as long as the polyvinyl alcohol content determined macroscopically is in the mentioned range. Since optical quality may not be important with the inventive films, depending on the design of the mirror system, polyvinyl acetals from recycling processes using laminated glass or automotive windshields, colored or opaque batches may also be used.

In a second variant of the invention, polyvinyl acetals whose weight-average molecular weight Mw is greater than 110,000 g/mol, preferably greater than 120,000 g/mol, and/or whose solution viscosity is greater than 80 mPas, preferably greater than 90 mPas, are used to produce the inventive films. The polyvinyl alcohol content of the polyvinyl acetal used must of course be within the aforementioned range. The molecular weight Mw and solution viscosity are measured, as indicated in the examples, by using gel permeation chromatography (GPC) and a 5% solution of the polyvinyl acetals in ethanol, respectively. In order not to interfere with the extrudability of the polyvinyl acetals, the molecular weight Mw should not be greater than 500,000 g/mol and/or the solution viscosity should not be greater than 300 mPas.

The molecular weight Mw and solution viscosity are values determined macroscopically on the polyvinyl acetal that is used. Therefore, mixtures of several polyvinyl acetals whose molecular weight Mw or solution viscosity is above or below the limit values indicated, respectively, may therefore also be used. Those skilled in the art are familiar with blending of several polyvinyl acetals to obtain a mixture with the aforementioned lower limits for the molecular weight Mw and/or the solution viscosity.

An increased molecular weight and/or solution viscosity can be achieved by using the corresponding polyvinyl alcohols to produce the polyvinyl acetals according to the invention. The polyvinyl alcohols used to produce the polyvinyl acetals preferably have a solution viscosity of more than 35 mPas, measured in a 4% aqueous solution. The polyvinyl alcohols may be pure within the context of the present invention or may be used as a mixture of polyvinyl alcohols with different degrees of polymerization or degrees of hydrolysis. If mixtures of polyvinyl alcohols are used, their solution viscosity according to the invention is greater than 35 mPas.

The polyvinyl alcohols required to produce the subject invention films are obtained by known methods, by reacting polyvinyl alcohols which have a corresponding molecular weight and a residual acetate content, with one or more aldehydes.

Within the scope of the present invention, in addition to copolymers of vinyl alcohol and vinyl acetate, terpolymers of hydrolyzed ethylene-vinyl acetate copolymers may also be used as the polyvinyl alcohol. These compounds are usually more than 98% hydrolyzed and contain 1 to 10 wt % of units based on ethylene (for example, the “Exceval®” type from Kuraray Europe GmbH).

Within the scope of the present invention, hydrolyzed copolymers of vinyl acetate and at least one other ethylenically unsaturated monomer may also be used as the polyvinyl alcohol.

It is possible to perform the acetalization using aldehydes with 2-10 carbon atoms, preferably with acetaldehyde, butyraldehyde or valeraldehyde.

In another variant of the invention, i.e., the third variant, the polyvinyl acetals used according to the invention have an increased molecular weight due to crosslinking via carboxyl groups, by polyaldehydes, glutardialdehydes or glyoxylic acid, and they have an increased solution viscosity.

Crosslinked polyvinyl acetals are preferably accessible by intramolecular crosslinking of polyvinyl acetals having carboxyl group substituents. These can be produced by co-acetalization of polyvinyl alcohols with polyaldehydes, glutardialdehyde or glyoxylic acid, for example.

The production of crosslinkable polyvinyl acetals and the crosslinking reaction are described in EP 1527107 B1 and WO 2004/063231 A1 (thermal self-crosslinking of carboxyl group-containing polyvinyl acetals), EP 1606325 A1 (polyvinyl acetals crosslinked with polyaldehydes), EP 1622946 A1 (with polyvinyl acetals crosslinked with glutardialdehyde) and WO 03/020776 A1 (polyvinyl acetals crosslinked with glyoxylic acid), for example. The disclosures of these references are incorporated herein by reference.

The crosslinkable polyvinyl acetals most preferably meet the lower limits already described above for the molecular weight Mw and/or the solution viscosity of unsubstituted polyvinyl acetals. The crosslinking is detectable macroscopically via an increased molecular weight and/or an increased viscosity of an ethanolic solution. Preferably 0.001 to 1% of the OH groups originally present in the respective polyvinyl acetal react due to the crosslinking.

In a forth variant of the present invention, the properties of the polyvinyl acetals used according to the invention are adjusted by the acetalization conditions during their production. In the production of polyvinyl acetals, a mixture of polyvinyl alcohol and aldehyde or polyvinyl alcohol and an acid, for example HCl, is usually used as the starting mixture, which is then reacted (precipitation phase) by adding an acid and/or an aldehyde at a temperature of 0 to 20° C. with precipitation of the polyvinyl acetal. The precipitation phase begins with the addition of the last component (acid or aldehyde) and usually lasts between 60 and 360 minutes, preferably between 60 and 240 minutes. The precipitation phase ends with the start of heating to the final temperature.

The onset of heating is the start of the heating phase. Next, the reaction is completed at a final temperature of 30 to 80° C., after which the reaction mixture is cooled and the polyvinyl acetal is separated and processed. The heating phase ends with the start of cooling and usually lasts between 30 and 300 minutes.

Polyvinyl acetals, produced with methods comprising the following steps, are especially suitable for the inventive mirrors:
starting with an aqueous solution of polyvinyl alcohol and at least one aldehyde,
adding an acid and precipitating the polyvinyl acetal at a low temperature (precipitation phase), whereupon the precipitation phase lasts between 60 and 360 minutes, preferably between 60 and 240 minutes.

Alternatively, the precipitation phase may also be performed as follows:
starting with an aqueous solution of polyvinyl alcohol and acid,
adding at least one aldehyde with precipitation of the polyvinyl acetal at a low temperature (precipitation phase), where the precipitation phase lasts between 60 and 360 minutes, preferably between 60 and 240 minutes.

The acid and aldehyde may be added all at once or continuously or incrementally in both variants.

Then the following process step is performed in both variants (heating phase):
heating the reaction mixture to an elevated temperature,
reheating at an elevated temperature, where the entire heating phase lasts between 30 and 300 minutes.

Polyvinyl acetals suitable for the present invention are produced with a much longer precipitation phase in comparison with the heating phase as described in DE 2838025, U.S. Pat. No. 5,187,217, EP 1384731, WO 2004/005358, EP 0211819 JP 01318009 or WO 2005 070669, for example, which are incorporated herein by reference. The polyvinyl acetals obtained in this way most preferably have the lower limits for the molecular weight Mw and/or the solution viscosity as already described.

In a fifth variant of the invention, especially suitable polyvinyl acetals for the present invention are obtained by combining a production process with a long precipitation phase as in the third variant, with a crosslinking reaction, e.g., by thermal self-crosslinking of carboxyl group-containing polyvinyl acetals, by crosslinking the polyvinyl acetal with polyaldehyde, glutaraldehyde or glyoxylic acid. The crosslinking reaction may take place during production of the polyvinyl acetal (i.e., the reaction of polyvinyl alcohol with aldehyde) by simultaneous addition of the aldehyde and the crosslinking agent or in a separate reaction step, such as the addition of the crosslinking agent to the extrusion of the plasticizer-containing film. The polyvinyl acetals obtained in this way most preferably have the lower limits described above for the molecular weight Mw or the solution viscosity.

Regardless of the production method and crosslinking, the polyvinyl acetals used according to the present invention also contain units resulting from vinyl acetate and vinyl alcohol and optionally have additional comonomers besides the acetal units.

The polyvinyl acetate content of the polyvinyl acetals used according to the present invention is preferably less than 14 wt %, more preferably less than 10 wt % yet more preferably less than 5 wt %, and in particular less than 2 wt %. The degree of acetalization can be determined by calculation from the polyvinyl alcohol content and the residual acetate content.

The films used according to the present invention preferably have moisture and/or water levels of, in order of increasing preference, less than 2.3 wt %, 2.0 wt %, 1.8 wt % and most preferably 1.5 wt %, even under humid conditions in the edge area. The moisture uptake by the plasticizer-containing film based on polyvinyl acetal, is additionally determined by the proportion and polarity and/or plasticizing effect of the plasticizer used. The moisture uptake by the film may thus also be adjusted easily through the plasticizer.

The films preferably have a plasticizer content in the range of 18 to 32 wt %, more preferably in the range of 20 to 30 wt %, yet more preferably in the range of 22 to 28 wt %, and in particular in the range 24 to 27 wt %. Films used according to the invention may contain one or more plasticizers.

One or more of the following plasticizers, defined by a polarity, expressed by the formula 100×O/(C+H)≦9.4, where O, C and H stand for the number of oxygen, carbon and hydrogen atoms in the respective molecule, are especially suitable according to the invention. The following table shows plasticizers that may be used according to the invention and their polarity values according to the formula 100×O/(C+H).

| Name | Abbreviation: | 100 × O/(C + H) |
|---|---|---|
| Di-2-ethylhexyl sebacate | (DOS) | 5.3 |
| Diisononyl adipate | (DINA) | 5.3 |
| 1,2-Cyclohexane dicarboxylic acid | (DINCH) | 5.4 |
| diisononyl ester | | |
| Di-2-ethylhexyl adipate | (DOA) | 6.3 |
| Di-2-ethylhexyl phthalate | (DOP) | 6.5 |
| Dihexyl adipate | (DHA) | 7.7 |
| Dibutyl sebacate | (DBS) | 7.7 |
| Di-2-butoxyethyl sebacate | (DBES) | 9.4 |
| Triethylene glycol bis-2-ethyl- | (3G8) | 9.4 |
| hexanoate | | |
| Triethylene glycol bis-n-heptanoate | 3G7 | 10.3 |
| Tetraethylene glycol bis-n-heptanoate | 4G7 | 10.9 |
| Di-2-butoxyethyl adipate | DBEA | 11.5 |
| Di-2-butoxyethoxyethyl adipate | DBEEA | 12.5 |

The power of polyvinyl acetal films to adhere to glass is usually adjusted by adding adhesion regulators, for example, the alkali and/or alkaline earth salts of organic acids, as disclosed in WO 03/033583 A1. These act simultaneously as basic stabilizers, which prevent back-cleavage of the acetal group. Magnesium acetate has been found to be especially suitable as a stabilizer. Furthermore, polyvinyl acetals from this synthesis process often contain alkali and/or alkaline earth salts of inorganic acids, for example, sodium chloride.

Since these salts also have an effect on the corrosion of the film, it is expedient to use plasticizer-containing films based on polyvinyl acetal and containing less than 70 ppm, more preferably less than 50 ppm and in particular less than 30 ppm of alkali metal ions. This may be achieved through appropriate washing processes.

The inventive film c) preferably contains, in order of increasing preference, more than 5 ppm, more preferably more than 10 ppm, yet more preferably more than 15 ppm, more than 20 ppm, more than 30 ppm, more than 50 ppm, more than 70 ppm and most preferably more than 90 ppm of one or more ions selected from the group of Be, Mg, Ca, Sr, Ba, Ra, Zn and Al. On the other hand, however, to avoid unwanted turbidity, no more than 500 ppm of the aforementioned polyvalent metals should be present.

In addition, the power of the film to adhere to glass surfaces may be influenced by adding pyrogenic or precipitated silica. The plasticizer-containing films based on polyvinyl acetal preferably contain 0.001 to 15 wt %, more preferably 0.01 to 10 wt %, and in particular 0.5 to 5 wt % SiO₂.

The basic production and composition of films based on polyvinyl acetals is known, and is described in EP 185 863 B1, EP 1 118 258 B1 WO 02/102591 A1, EP 1 118 258 B1 or EP 387 148 B1, for example.

The mirror elements are laminated in such a manner as to yield a bubble-free and haze-free inclusion of the mirror materials.

In one variant of the inventive mirrors, the sunlight-reflecting layers are applied to the cover d) (e.g., by vapor deposition, gas phase deposition, sputtering or wet deposition) and bonded to the cover a) by a film c). The thickness of the polyvinyl acetal-based films containing plasticizer is preferably between 0.2 and 2.5 mm.

The transparent front cover is usually made of glass or PMMA. The rear cover of the inventive mirror may be made of glass, plastic, metal or composites thereof, whereby at least one of the backings may be transparent. It is also possible to design one or both covers as laminated glazing (i.e., as a laminate of at least two panes of glass and at least one PVB film) or as insulation glazing having a gas interspace. It is of course also possible to combine these measures.

The layers b) used in the inventive mirrors which reflect sunlight are not critical. Suitable materials include, for example, silver, aluminum, chromium and gold, which may be applied in one or more layers. Mirror layers that may be used in solar power plants and their production are disclosed in WO 2007/108861, U.S. Pat. No. 4,422,893 or U.S. Pat. No. 4,511,688, for example. It is self-evident that the reflective layers should reflect the incident sunlight without any intrinsic absorption, if possible.

In one variant of the present invention, a layered body is assembled from the rear backing/cover d) provided with the reflective layer b), at least one plasticizer-containing film c) based on polyvinyl acetal and a transparent front cover, and then is bonded at an elevated temperature.

Alternatively, the reflective layer b) may be applied as a backing to the transparent front cover and bonded to the rear cover by at least one film c) based on plasticizer-containing polyvinyl acetal inserted in between.

The conventional methods with which those skilled in the art are familiar, with and without prior production of a prelaminate, may be used for lamination of the resulting layered body.

So-called “autoclave processes” are performed at an elevated pressure of approximately 10 to 15 bar and at temperatures of 130° C. to 145° C. for approximately 2 hours. Vacuum bag methods or vacuum ring methods, e.g., according to EP 1 235 683 B1, operate at approximately 200 mbar and 130° C. to 145° C.

Vacuum laminators are preferably used to produce the inventive mirrors. These consist of a chamber which can be heated and evacuated and in which the composite glazings can be laminated within 30-60 minutes. Reduced pressures of 0.01 to 300 mbar and temperatures of 100° C. to 200° C., in particular 130° C. to 160° C. have proven successful in practice.

Alternatively, a layered body assembled as described above may be pressed between at least one pair of rollers at a temperature of 60 to 150° C. to form an inventive minor. Systems of this type are known for production of composite glazings and normally have at least one heating tunnel upstream and/or downstream from the first press works in systems having two press works.

In one variant of the present invention, a thin front pane of glass, which is initially planar and on whose backside the mirror layer is situated, is bonded with the help of the inventive film c) to a thicker, curved rear glass, such that the thinner front glass is permanently adapted to the curvature of the rear glass. The thin front pane is preferably made of a glass having a low iron content.

In addition, the subject matter of the present invention is the use of plasticizer-containing film c) based on polyvinyl acetal and having a polyvinyl alcohol content of the polyvinyl acetal of less than 20 wt % for production of mirrors for solar thermal power plants. These mirrors preferably comprise a laminate of

a) a transparent front cover,
b) one or more layers which reflect sunlight,
c) at least one plasticizer-containing film based on polyvinyl acetal, and
d) a rear cover.

For production of the mirrors, films c) having the preferred embodiments described here may be used, in particular those having a creep tendency of less than 5 mm after seven days at a temperature of 100° C., determined on a laminate comprising 3 mm float glass/0.76 mm film c)/3 mm float glass.

Inventive mirrors may be used in the form of planar mirrors, e.g., for solar thermal power plants or Fresnel collector systems or curved mirrors, e.g., as paraboloid mirrors in paraboloid power plants according to FIG. 1 or as linear concentrators.

### Measurement Methods:

The flow behavior of the film is determined as the melt-flow rate (MFR) according to ISO 1133 on a corresponding apparatus, e.g., model MI2 from the company Göttfert. The MFR value is reported in grams per 10 minutes (g/10 min) at the corresponding temperatures of 100° C. and 140° C., for example, with a 2 mm nozzle at a weight load of 21.6 kg.

The polyvinyl alcohol content and the polyvinyl alcohol acetate content of the polyvinyl acetals were determined according to ASTM D 1396-92.

The analysis of the metal ion content was performed by atomic absorption spectroscopy (AAS).

The molecular weight Mw (weight-average) of the polyvinyl acetals was determined in glacial acetic acid using RI detectors. The detectors were calibrated by using PVB calibration standards whose absolute values were determined by static light scatter.

The solution viscosity of the polyvinyl acetals was measured according to DIN 53015 at 20° C. in a mixture of 95 parts ethanol and 5 parts water. The solids content of the viscosity solution was 5 wt %.

The solution viscosity of the polyvinyl alcohols was measured according to DIN 53015 at 20° C. in water. The solids content of the viscosity solution was 4 wt %.

The water content and/or moisture content of the films is determined using the Karl Fischer method in wt %. For simulation of the moisture behavior under humid conditions, the film is first stored for 24 h at 23° C. and 85% relative humidity. This method may be performed on the unlaminated film as well as on a laminated photovoltaic module, depending on the distance from the edge of the film.

### Test for Creep Tendency

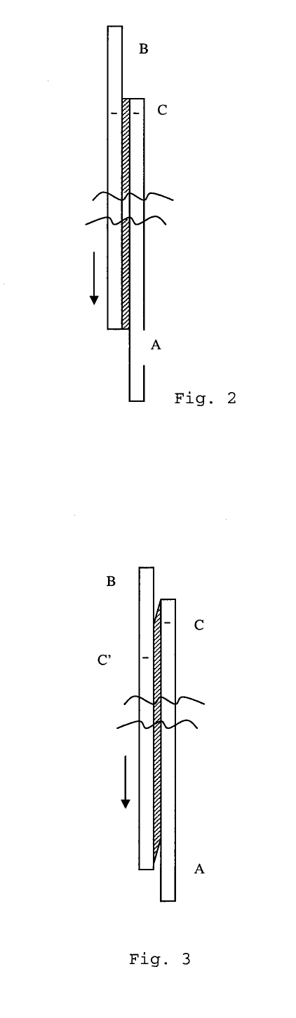

The creep tendency of the films is determined on test laminates produced from two pieces of float glass of a thickness of 3 mm and with edge dimensions of 150×300 mm with the laminated film with a thickness of 0.76 mm in between, so that the two panes of glass have an offset of 2 cm from one another (A/B in FIGS. 2 and 3). The film, which is tested for its creep tendency, is conditioned overnight in a climate of 23° C./23% relative humidity before producing the laminate.

The two protruding sections of glass are not covered by film; i.e., the laminated intermediate layer has a length of only 28 cm. The test laminates are marked with crosswise marks exactly opposite one another on both sides using a pen; the resulting offset due to slippage can be measured easily later on the basis of these marks (C in FIG. 2). The test laminates are placed or mounted vertically in a heating cabinet at 100° C., so that the front glass (B in FIGS. 2 and 3), which does not come in contact with the bottom, can slide freely under its own weight, i.e., it is held only by the intermediate film and is in contact only with the latter, so that the result is not falsified by frictional effects. After 7 days (one week), the test laminates are examined for offset by measuring the distance between the two marks using a ruler (C and C′ in FIG. 3).

### EXAMPLES

Films 0.76 mm thick were prepared using mixtures of the compositions listed in the following tables and were tested for their suitability for production of photovoltaic modules, i.e., their creep tendency and electric breakdown resistance, by testing them in the form of laminates between two panes of white glass (Optiwhite) 3 mm thick.

It was found that the films of the invention can be processed well to form mirrors for solar thermal power plants. However, the low creep values (slippage) at 100° C. indicate a low flowability at this temperature, so that a stable mirror with respect to environmental and mechanical influences is obtained.

Films having the flow properties described above are especially suitable for production of mirrors for solar thermal power plants because they do not exhibit any slippage of the metallic coated front pane in comparison with the back pane, but they can nevertheless be processed well. At the same time, the low moisture uptake by the films produces reduced corrosion of the metallic mirror layers.

The abbreviations used in the examples are as follows:
DINCH 1,2-cyclohexane dicarboxylic acid diisononyl ester
3G8 triethylene glycol bis-2-ethylhexanoate
PVB polyvinyl butyral with the PVA content indicated

### Comparative Example 1

100 parts by weight of the polyvinyl alcohol Mowiol 28-99 (commercial product of Kuraray Europe GmbH) were dissolved in 1075 parts by weight water, while heating to 90° C. At a temperature of 40° C., 56.8 parts by weight n-butyraldehyde were added, and at a temperature of 12° C., 75 parts by weight 20% hydrochloric acid were added within 6 minutes while stirring, after which the polyvinyl butyral (PVB) was precipitated. The mixture was then kept at 12° C. for 15 minutes while stirring, then heated to 69° C. within 80 minutes and kept at this temperature for 120 minutes. The PVB was separated after cooling to room temperature, washed until neutral and dried, yielding a PVB having a polyvinyl alcohol content of 20.2 wt % and a polyvinyl acetate content of 1.5 wt %.

290 g of the PVB obtained in this way and 100 g plasticizer 3G8 and 10 g DBEA plasticizer were mixed in a laboratory mixer (manufacturer: Brabender, model 826801). The resulting mixture was extruded to form a flat film with a thickness of 0.8 mm. The film was extruded on a twin-screw extruder using contra-rotating screws (manufacturer: Haake, Rhecord 90 system), equipped with a melt pump and a flat-sheet die. The cylinder temperature of the extruder was 220° C. and the nozzle temperature was 150° C.

### Comparative Example 2

In polymer synthesis, 63.9 parts by weight n-butyraldehyde were used. In film production, 370 g PVB and 130 g DINCH plasticizer were used. The remaining procedure was the same as that according to Comparative Example 1.

### Comparative Examples 3-4

In polymer synthesis, 66.3 and 68.4 parts by weight n-butyraldehyde were used. The remaining procedure was the same as that according to Comparative Example 2.

### Examples 1, 2 and 3

In polymer synthesis, 100 parts by weight of the polyvinyl alcohol Mowiol 56-98 (commercial product of Kuraray Europe GmbH), 1333 parts by weight water and 67.9, 68.4 and 69 parts by weight n-butyraldehyde were used. The remaining procedure was the same as that according to Comparative Example 2.

### Example 4 and 5

In polymer synthesis, 100 parts by weight of the polyvinyl alcohol Kuraray Poval 624 (commercial product of Kuraray Co. Ltd.), 1333 parts by weight water, 100 parts by weight 20% hydrochloric acid and 70 or 73 parts by weight n-butyraldehyde were used. The remaining procedure was the same as that according to Comparative Example 2.

### Comparative Example 5

In film production, a mixture of 333 g PVB from Comparative Example 4 and 37 g PVB from Example 2 was used. The remaining procedure was the same as that according to Comparative Example 2.

### Example 6

In film production, a mixture of 259 g PVB from Comparative Example 4 and 111 g PVB from Example 2 was used. The remaining procedure was the same as that according to Comparative Example 2.

### Example 7

In film production, a mixture of 185 g PVB from Comparative Example 4 and 185 g PVB from Example 2 was used. The remaining procedure was the same as that according to Comparative Example 2.

### Example 8

In film production, a mixture of 185 g PVB from Comparative Example 4 and 185 g PVB from Example 3 was used. The remaining procedure was the same as that according to Comparative Example 2.

### Examples 9-12

In polymer synthesis, 68.4 parts by weight n-butyraldehyde plus 0.02, 0.04, 0.06 and 0.08 parts by weight glutaraldehyde were used. The remaining procedure was the same as that according to Comparative Example 2.

### Example 13-14

In polymer synthesis, 100 parts by weight of the polyvinyl alcohol Mowiol 30-92 (commercial product of Kuraray Europe GmbH), 1075 parts by weight water, 67.1 parts by weight n-butyraldehyde, 100 parts by weight 20% hydrochloric acid and 0.04 or 0.08 parts by weight glutaraldehyde were used. The remaining procedure was the same as that according to Comparative Example 2.

### Example 15

100 parts by weight of the polyvinyl alcohol Mowiol 28-99 (commercial product of Kuraray Europe GmbH) were dissolved in 1075 parts by weight water while heating to 90° C. At a temperature of 40° C., 68.4 parts by weight n-butyraldehyde were added, and 15 parts by weight 20% hydrochloric acid were added within 15 minutes at a temperature of 12° C. while stirring, whereupon the polyvinyl butyral (PVB) was precipitated. The mixture was then kept at 12° C. for 60 minutes while stirring. Next 50 parts by weight more 20% hydrochloric acid were added within 40 minutes. The mixture was then kept at 12° C. for 15 minutes while stirring, then heated to 69° C. within 80 minutes and kept at this temperature for 120 minutes. The remaining procedure was the same as that according to Comparative Example 2.

### Examples 16-17

The pause after adding the first partial amount of acid was 120 minutes or 180 minutes. The remaining procedure was according to Example 15.

### Example 18

100 parts by weight of the polyvinyl alcohol Mowiol 28-99 (commercial product of Kuraray Europe GmbH) were dissolved in 1075 parts by weight water while heating to 90° C. At a temperature of 40° C., 68.4 parts by weight n-butyraldehyde and 0.03 parts by weight glutaraldehyde were added. At a temperature of 12° C., 75 parts by weight 20% hydrochloric acid were added within 6 minutes while stirring, whereupon the polyvinyl butyral (PVB) was precipitated. The mixture was then kept at 12° C. for 120 minutes while stirring, then heated to 69° C. within 80 minutes and kept at this temperature for 120 minutes. The remaining procedure was the same as that in Comparative Example 2.

### Example 19

100 parts by weight of the polyvinyl alcohol Mowiol 28-99 (commercial product of Kuraray Europe GmbH) were dissolved in 1075 parts by weight water while heating to 90° C. At a temperature of 40° C., 68.4 parts by weight n-butyraldehyde and 0.03 parts by weight glutaraldehyde were added.

At a temperature of 12° C., 15 parts by weight 20% hydrochloric acid were added within 15 minutes while stirring, whereupon the polyvinyl butyral (PVB) was precipitated. The mixture was then kept at 12° C. for 120 minutes while stirring. Next 50 parts by weight 20% hydrochloric acid were added within 40 minutes. The mixture was then kept at 12° C. for 15 minutes while stirring, then heated to 69° C. within 80 minutes and kept at this temperature for 120 minutes. The remaining procedure was the same as that according to Comparative Example 2.

### Examples 20-21

100 parts by weight of the polyvinyl alcohol Mowiol 30-92 (commercial product of Kuraray Europe GmbH) were in 1075 parts by weight water while heating to 90° C. At a temperature of 40° C., 67.1 parts by weight n-butyraldehyde and 0.06 parts by weight glutaraldehyde were added. At a temperature of 12° C., 100 parts by weight 20% hydrochloric acid were added within 6 minutes while stirring, whereupon the polyvinyl butyral (PVB) precipitated. The mixture was then kept at 12° C. for another 60 minutes or 120 minutes while stirring, then heated to 69° C. within 80 minutes and kept at this temperature for 120 minutes. The remaining procedure was the same as that according to Comparative Example 2.

TABLE 1

| Example | Comp. Ex. 1 | Comp. Ex. 2 | Comp. Ex. 3 | Comp. Ex. 4 | Comp. Ex. 5 |
|---|---|---|---|---|---|
| PVB | | | | | |
| Viscosity PVA 4% (mPa · s) | 27.06 | 27.06 | 27.06 | 27.06 | — |
| Precipitation phase [minutes] | 21 | 21 | 21 | 21 | — |
| Heating phase [minutes] | 200 | 200 | 200 | 200 | — |
| Polyvinyl alcohol content [wt %] | 20.2 | 16.0 | 15.0 | 14.3 | 14.4 |
| Polyvinyl acetate content [wt %] | 1.5 | 0.9 | 1.1 | 0.9 | 1.0 |
| Butyral content [wt %] | 78.3 | 83.1 | 83.9 | 84.8 | 84.6 |
| Polyvinyl alcohol content [mol %] | 29.1 | 23.5 | 22.2 | 21.2 | 21.4 |
| Polyvinyl acetate content [mol %] | 1.1 | 0.7 | 0.8 | 0.7 | 0.8 |
| Butyral content [mol %] | 69.8 | 75.8 | 77.0 | 78.1 | 77.9 |
| Viscosity of PVB 5% (mPa · s) | 81.4 | 68.2 | 70 | 72.9 | 90.1 |
| Film | | | | | |
| Plasticizer | 3G8/DBEA | DINCH | DINCH | DINCH | DINCH |
| | (10:1) | | | | |
| Plasticizer [wt %] | 27.5 | 26.0 | 26.0 | 26.0 | 26.0 |
| Mw, PVB [g/mol] | 103000 | 103800 | 103000 | 101950 | 106000 |
| MFR 100° C./21.6 kg [mg/10 min.] | 165 | 397 | 465 | 378 | 351 |
| Water content according to Karl | 3.09 | 1.87 | 1.73 | 1.87 | 1.67 |
| Fischer in wt % | | | | | |
| Creep in mm | 0 | 8.5 | 9 | 7 | 5 |

TABLE 2

| Example | Ex. 1 | Ex. 2 | Ex. 3 | Ex. 4 | Ex. 5 | Ex. 6 |
|---|---|---|---|---|---|---|
| PVB | | | | | | |
| Viscosity PVA 4% (mPa · s) | 56.36 | 56.36 | 56.36 | 55.92 | 55.92 | — |
| Precipitation phase [minutes] | 21 | 21 | 21 | 21 | 21 | — |
| Heating phase [minutes] | 200 | 200 | 200 | 200 | 200 | — |
| Polyvinyl alcohol content [wt %] | 15.6 | 15.0 | 14.1 | 13.5 | 12.7 | 14.5 |
| Polyvinyl acetate content [wt %] | 2.0 | 2.1 | 1.9 | 5.4 | 5.7 | 1.3 |
| Butyral content [wt %] | 82.4 | 83.0 | 84.0 | 81.1 | 81.6 | 84.2 |
| Polyvinyl alcohol content [mol %] | 23.0 | 22.2 | 21.0 | 20.3 | 19.2 | 21.5 |
| Polyvinyl acetate content [mol %] | 1.5 | 1.6 | 1.5 | 4.1 | 4.4 | 1.0 |
| Butyral content [mol %] | 75.5 | 76.2 | 77.6 | 75.6 | 76.4 | 77.5 |
| Viscosity PVB 5% (mPa · s) | 179.8 | 177.3 | 177.8 | 195.8 | 205.9 | 105.5 |
| Film | | | | | | |
| Plasticizer | DINCH | DINCH | DINCH | DINCH | DINCH | DINCH |
| Plasticizer [wt %] | 26.0 | 26.0 | 26 | 26 | 26 | 26.0 |
| Mw, PVB [g/mol] | 143300 | 144300 | 143775 | 150800 | 150200 | 113500 |
| MFR 100° C./21.6 kg [mg/10 min.] | 88 | 83 | 97 | 84 | 97 | 263 |
| Water content according to Karl | 1.79 | 1.76 | 1.7 | 1.61 | 1.55 | 1.69 |
| Fischer in wt % | | | | | | |
| Creep in mm | 1 | 1 | 0 | 1 | 1 | 2 |

TABLE 3

| Example | Ex. 7 | Ex. 8 | Ex. 9 | Ex. 10 | Ex. 11 | Ex. 12 |
|---|---|---|---|---|---|---|
| PVB | — | — | | | | |
| Viscosity PVA 4% (mPa · s) | — | — | 26.8 | 27.06 | 27.06 | 27.06 |
| Precipitation phase [minutes] | — | — | 21 | 21 | 21 | 21 |
| Heating phase [minutes] | — | — | 200 | 200 | 200 | 200 |
| Polyvinyl alcohol content [wt %] | 14.7 | 14.2 | 14.5 | 14.5 | 14.2 | 14.4 |
| Polyvinyl acetate content [wt %] | 1.5 | 1.4 | 1.2 | 0.9 | 1.0 | 0.9 |
| Butyral content [wt %] | 83.8 | 84.4 | 84.3 | 84.6 | 84.8 | 84.7 |
| Polyvinyl alcohol content [mol %] | 21.8 | 21.1 | 21.5 | 21.6 | 21.2 | 21.3 |
| Polyvinyl acetate content [mol %] | 1.1 | 1.1 | 0.9 | 0.7 | 0.8 | 0.7 |
| Butyral content [mol %] | 77.1 | 77.8 | 77.6 | 77.8 | 78.1 | 78.0 |
| Viscosity PVB 5% (mPa · s) | 120 | 120 | 79.8 | 90.9 | 103.7 | 120.5 |
| Film | | | | | | |
| Plasticizer | DINCH | DINCH | DINCH | DINCH | DINCH | DINCH |
| Plasticizer [wt %] | 26.0 | 26 | 26.0 | 26.0 | 26.0 | 26.0 |
| Mw, PVB [g/mol] | 122300 | 122400 | 111450 | 127200 | 141850 | 159600 |
| MFR 100° C./21.6 kg [mg/10 min.] | 172 | 180 | 340 | 227 | 189 | 105 |
| Water content according to Karl | 1.69 | 1.64 | 1.62 | 1.63 | 1.72 | 1.67 |
| Fischer in wt % | | | | | | |
| Creep in mm | 1 | 0 | 4 | 1 | 1 | 0 |

TABLE 4

| Example | Ex. 13 | Ex. 14 | Ex. 15 | Ex. 16 | Ex. 17 | Ex.18 |
|---|---|---|---|---|---|---|
| PVB | | | | | | |
| Viscosity PVA 4% (mPa · s) | 30.75 | 30.75 | 27.06 | 27.06 | 27.06 | 27.06 |
| Precipitation phase [minutes] | 21 | 21 | 115 | 175 | 235 | 126 |
| Heating phase [minutes] | 200 | 200 | 200 | 200 | 200 | 200 |
| Polyvinyl alcohol content [wt %] | 11.1 | 11.3 | 14.5 | 15.1 | 14.8 | 15.0 |
| Polyvinyl acetate content [wt %] | 9.0 | 8.8 | 1.0 | 0.9 | 0.9 | 1.0 |
| Butyral content [wt %] | 79.9 | 79.9 | 84.5 | 84.0 | 84.2 | 84.0 |
| Polyvinyl alcohol content [mol %] | 17.0 | 17.3 | 21.5 | 22.3 | 22.0 | 22.2 |
| Polyvinyl acetate content [mol %] | 7.1 | 6.9 | 0.7 | 0.7 | 0.7 | 0.8 |
| Butyral content [mol %] | 75.9 | 75.8 | 77.7 | 77.0 | 77.3 | 77.0 |
| Viscosity PVB 5% (mPa · s) | 111.6 | 152.1 | 83.6 | 87.8 | 88.3 | 90.4 |
| Film | | | | | | |
| Plasticizer | DINCH | DINCH | DINCH | DINCH | DINCH | DINCH |
| Plasticizer [wt %] | 26 | 26 | 26.0 | 26 | 26 | 26 |
| Mw, PVB [g/mol] | 141800 | 172400 | 102525 | 103225 | 102075 | 116700 |
| MFR 100° C./21.6 kg [mg/10 min.] | 221 | 103 | 156 | 131 | 116 | 253 |
| Water content according to Karl | 1.52 | 1.54 | 1.64 | 1.68 | 1.7 | 1.78 |
| Fischer in wt % | | | | | | |
| Creep in mm | 3 | 0 | 1 | 0 | 0 | 2 |

TABLE 5

| Example | Ex. 19 | Ex. 20 | Ex. 21 |
|---|---|---|---|
| PVB | | | |
| Viscosity PVA 4% (mPa · s) | 27.06 | 30.75 | 30.75 |
| Precipitation phase [minutes] | 175 | 106 | 166 |
| Heating phase [minutes] | 200 | 200 | 200 |
| Polyvinyl alcohol content [Wt %] | 14.7 | 11.8 | 11.6 |
| Polyvinyl acetate content [wt %] | 1.1 | 9.2 | 9.6 |
| Butyral content [wt %] | 84.2 | 79.0 | 78.8 |
| Polyvinyl alcohol content [Mol %] | 21.8 | 18.0 | 17.8 |
| Polyvinyl acetate content [mol %] | 0.8 | 7.2 | 7.5 |
| Butyral content [mol %] | 77.4 | 74.8 | 74.7 |
| Viscosity PVB 5% (mPa · s) | 102.6 | 131.6 | 124.2 |
| Film | | | |
| Plasticizer | DINCH | DINCH | DINCH |
| Plasticizer [wt %] | 26 | 26 | 26 |
| Mw, PVB [g/mol] | 115400 | 160500 | 155400 |
| MFR 100° C./21.6 kg [mg/10 min.] | 106 | 121 | 181 |
| Water content according to Karl | 1.68 | 1.54 | 1.5 |
| Fischer in wt % | | | |
| Creep in mm | 0 | 0 | 1 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A mirror for solar thermal power plants, comprising a laminate of
a) a transparent front cover,
b) one or more sunlight-reflecting layers,
c) at least one plasticizer-containing polyvinyl acetal film, and
d) a back cover,
wherein the plasticizer-containing polyvinyl acetal film c) contains polyvinyl acetal with a polyvinyl alcohol content of less than 20 wt %.

2. The mirror for solar thermal power plants of claim 1, wherein the polyvinyl acetal has a molecular weight Mw of more than 110,000 g/mol.

3. The mirror for solar thermal power plants of claim 1, wherein the polyvinyl acetal film c) has a creep tendency of less than 5 mm, determined on a laminate with a structure comprising 3 mm float glass/0.76 mm film c)/3 mm float glass at a temperature of 100° C. after 7 days.

4. The mirror for solar thermal power plants of claim 2, wherein the polyvinyl acetal film c) has a creep tendency of less than 5 mm, determined on a laminate with a structure comprising 3 mm float glass/0.76 mm film c)/3 mm float glass at a temperature of 100° C. after 7 days.

5. The mirror for solar thermal power plants of claim 1, wherein the polyvinyl acetal is crosslinked by polyaldehydes, glutardialdehyde or glutaric acid via carboxyl groups.

6. The mirror for solar thermal power plants of claim 2, wherein the polyvinyl acetal is crosslinked by polyaldehydes, glutardialdehyde or glutaric acid via carboxyl groups.

7. The mirror for solar thermal power plants of claim 3, wherein the polyvinyl acetal is crosslinked by polyaldehydes, glutardialdehyde or glutaric acid via carboxyl groups.

8. The minor for solar thermal power plants of claim 5, wherein 0.001 to 1% of the OH groups originally present in the polyvinyl acetal react due to the crosslinking.

9. The mirror for solar thermal power plants of claim 1, wherein the plasticizer-containing polyvinyl acetal film c) contains from 20 to 30% by weight based on the weight of the film, of at least one plasticizer having a polarity of ≦9.4.

10. The minor for solar thermal power plants of claim 1, wherein the plasticizer-containing polyvinyl acetal film c) includes at least one polyvinyl acetal containing vinyl acetate units in an amount of less than 5 weight percent based on the weight of the polyvinyl acetal.

11. The minor for solar thermal power plants of claim 1, wherein the plasticizer-containing polyvinyl acetal film has creep tendency of 1 mm or less, and a moisture content after storage at 23° C. and 85% relative humidity for 24 hours is 1.8 weight percent or less based on the weight of the polyvinyl acetal film.

12. The mirror for solar thermal power plants of claim 11, wherein the creep tendency is 0 mm and the moisture content is ≦1.5 weight percent.

13. The mirror for solar thermal power plants of claims 1, wherein the plasticizer-containing film c) based on polyvinyl acetal contains more than 5 ppm magnesium ions.

14. The minor for solar thermal power plants of claim 1, wherein the polyvinyl acetal has a polyvinyl acetate content of less than 14 wt %.

15. The mirror for solar thermal power plants of claim 1, wherein the plasticizer-containing films c) based on polyvinyl acetal have a plasticizer content of 18 to 32 wt %.

16. The mirror for solar thermal power plants of claim 1, wherein the plasticizer comprises one or more compounds selected from the group consisting of di-2-ethylhexyl sebacate, di-2-ethylhexyl adipate, diisononyl adipate, dihexyl adipate, dibutyl sebacate, di-2-butoxyethyl sebacate, triethylene glycol bis-2-ethylhexanoate, and 1,2-cyclohexane dicarboxylic acid diisononyl ester.

17. The mirror for solar thermal power plants of claim 1, wherein the plasticizer-containing film based on polyvinyl acetal contains 0.001 to 15 wt % SiO₂.

18. In a process for the manufacture of a minor for solar thermal power production wherein multiple layers are bonded by a plastics film, the improvement comprising selecting as the plastics film a plasticizer-containing polyvinyl acetal film with a polyvinyl alcohol content of less than 20%.
